(19) United States
(12) Patent Application Publication
(10) Pub. No.: US 2026/0069942 A1
(43) Pub. Date: Mar. 12, 2026

(54) Pickleball Paddle Striking Blade With Soft Material Padded Openings

(71) Applicant: Ofinno, LLC, Reston, VA (US)

(72) Inventors: Esmael Hejazi DINAN, McLean, VA (US); Aaron GORE, Fairfax, VA (US)

(21) Appl. No.: 19/322,054

(22) Filed: Sep. 8, 2025

Related U.S. Application Data
(60) Provisional application No. 63/692,176, filed on Sep. 8, 2024.

(51) Int. Cl. A63B 59/42; A63B 60/50; A63B 60/54; A63B 102/08; B32B 3/12; B32B 3/26; B32B 5/18

(52) U.S. Cl. CPC A63B 59/42; A63B 60/50; A63B 60/54; B32B 3/12; B32B 3/266; B32B 5/18; A63B 2102/08; A63B 2209/00; B32B 2307/56

(57) ABSTRACT

According to an embodiment a pickleball paddle, comprising a handle, and a striking blade with one or more holes located in the striking blade is provided. At least some of the perimeter of the striking blade abuts a first layer of soft material and at least some of the perimeter of at least one of the one or more holes abut a second layer of soft material.

### CROSS REFERENCE TO RELATED APPLICATIONS

This application claims priority to U.S. Provisional Application No. 63/692,176 filed Sep. 8, 2024, the entire content of which is herein incorporated by reference.

### FIELD

This disclosure relates to pickleball, and more particularly to pickleball paddles.

### BACKGROUND

Pickleball, being a rapidly growing sport, is played by players who span a wide range of skill levels, ages, and physical capacities. The vibration generated in the paddle upon the striking blade hitting a ball may be substantial, and may affect the shots. Over time and continued use of the paddle, such vibrations can also impact players hands. Therefore, paddle manufacturers attempt to dampen vibrations in the paddle. Paddle cores comprising a honeycomb structure is relied on by many pickleball paddle manufacturers, and honeycomb structured cores provide a good balance of paddle strength and lower vibration generation (depending on the material of construction). However, in some pickleball paddles and/or for the playing styles of some players, the vibration damping provided by existing techniques is often found to be inadequate.

Therefore, there is a need to reduce the vibrations generated in pickleball paddles while not reducing the quality of performance of the paddle.

### SUMMARY OF EXAMPLE EMBODIMENTS

According to an embodiment a pickleball paddle, comprising a handle and a striking blade with one or more holes located in the striking blade is provided. At least some of the perimeter of the striking blade abuts a first layer of soft material and at least some of the perimeter of at least one of the one or more holes abut a second layer of soft material.

The soft material of the first layer and/or the second layer may comprise soft polymeric material, foamed polymer, foam, gel, and/or sponge.

The pickleball paddle may further comprise an edge guard, wherein at least a part of the first layer of soft material is between the edge guard and the perimeter of the striking blade.

The first layer may be between an edge guard of the pickleball paddle, and a core of the pickleball paddle.

The second layer may be between the at least some of a perimeter of at least one of the one or more holes, and a core of the pickleball paddle.

The first layer and the second layer may be connected to each other to form a connected layer. The first layer and the second layer may be connected to each other to form a circularly connected layer. The second layer may be formed in a groove configured on the striking blade.

The second layer may be thicker than the first layer.

The second layer may be of a different soft material than the first layer.

The first and second layers may be of the same soft material.

The second material may be configured for greater absorption of vibrations than the first layer.

The second layer may abut only a part of the perimeter of the any one of the one or more holes. The part of the perimeter that abuts the second layer may be closer to a sweet spot of the striking blade than a part of the perimeter that is away from the sweet spot.

The core of the striking blade may comprise a honeycomb layer. The core may be attached to two face sheet layers.

### BRIEF DESCRIPTION OF THE DRAWINGS

Some features are shown by way of example, and not by limitation, in the accompanying drawings. In the drawings, like numerals may reference similar elements.

FIG. 1A shows an example pickleball court, in which embodiments of the present disclosure may be applied.

FIG. 1B shows another view of a pickleball court.

FIGS. 2A and 2B show examples of conventional pickleball paddles.

FIG. 3 shows pickleball paddle specifications according to the United States Pickleball Association.

FIGS. 4A and 4B show example conventional pickleball paddles with each having a form layer in at least some of the perimeter of its striking blade.

FIGS. 5A, 5B, 5C and 5D show example conventional pickleball paddles of which the striking blades each have one or more holes for improved air dynamics and weight adjustment, and in each of which at least some of the perimeter of the striking blade abuts a layer of soft material.

FIG. 6 shows a pickleball paddle having a striking blade with two holes in the throat area of the striking blade and configured with foam layers abutting the perimeter of the striking blade and also abutting one of the holes in the throat area of the striking blade, according to some embodiments.

FIG. 7 shows a pickleball paddle having a striking blade with a hole in the throat area of the striking blade and configured with foam layers abutting the perimeter of the striking blade and also abutting the hole in the throat area of the striking blade, according to some embodiments.

FIG. 8 shows a pickleball paddle having a striking blade with one hole in the throat area and two holes on each of the left and right sides near the perimeter and configured with foam layers abutting the perimeter of the striking blade and also abutting the holes on the striking blade, according to some embodiments.

FIG. 9 shows a pickleball paddle having a striking blade with a hole in the throat area and configured with foam layers abutting the perimeter of the striking blade and also abutting at least one of the one or more holes on the striking blade, according to some embodiments.

### DETAILED DESCRIPTION OF EXAMPLE EMBODIMENTS

In the following description, numerous specific details are set forth in order to provide a thorough understanding of the disclosure. However, it will be apparent to those skilled in the art that the disclosure may be practiced without these specific details. The description and representation herein are the common means used by those experienced or skilled in the art to most effectively convey the substance of their work to others skilled in the art. In other instances, well-known methods, procedures, and components have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

This disclosure relates to “Pickleball,” a game that has in recent years seen a massive increase in popularity among all age groups of players, including among senior citizens. Pickleball is a game that can be described as combining aspects of tennis, badminton, and ping-pong. It is played on a badminton-sized court, with paddles and a ball similar to a wiffle ball, but slightly smaller in size. The net used in pickleball is similar to a tennis net in some ways, but is lowered at the center.

Pickleball has recently become very popular and is played both indoors and outdoors, as either doubles or singles. The rules are relatively simple and the game is easy for beginners to learn. However, among skilled players, pickleball can develop into a quick, fast-paced, and competitive game.

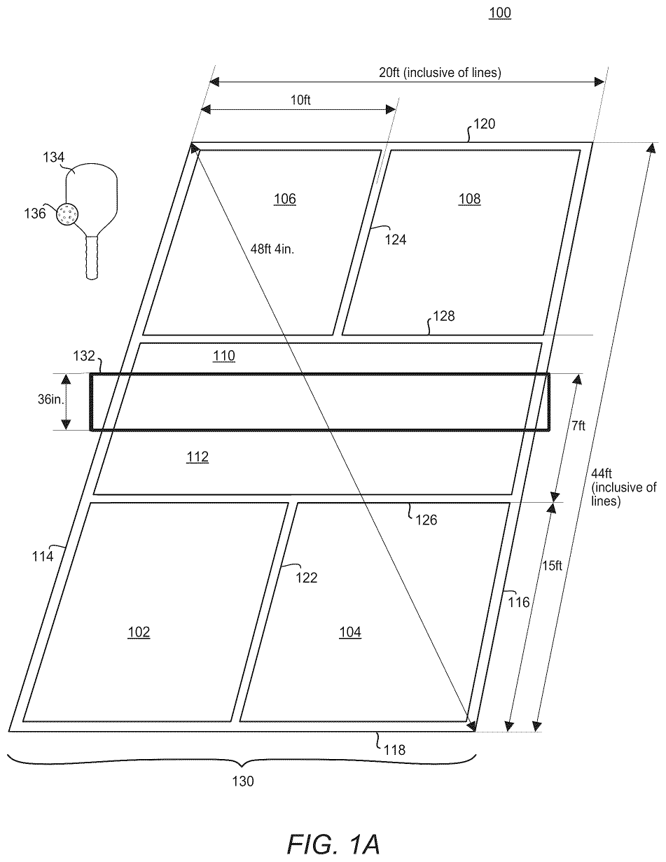

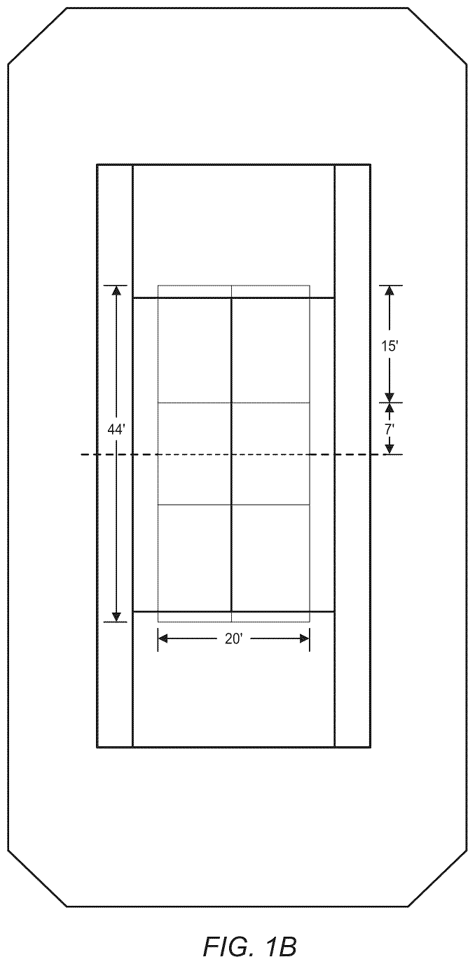

FIG. 1A shows an example pickleball court 100 that includes a pickleball playing surface 130 and a pickleball net 132. The playing surface 130 comprises two left serve areas 102 and 108, two right serve areas 104 and 106, and two non-volley areas 110 and 112, with one of the left serve areas, one of the right serve areas, and one of the non-volley areas being on each side of the pickleball net 132. The net is 36 inches tall at the edges, and lowered to 34 inches in the middle. The areas 102-112 are defined by baselines 118 and 120 each 20 feet, sidelines 114 and 116 each 44 feet, center lines 122 and 124 each 15 feet, and non-volley lines 126 and 128 each the same size as a baseline. Each of the lines may be 2 inches wide. The term “court line” is used in this disclosure to refer to any sideline, baseline, centerline or non-volley line on the pickleball court. Non-volley areas 110 and 112, each extending 7 feet from the net, are also referred to as the “kitchen”.

The game of pickleball is played with a pickleball paddle 134 and pickleball ball 136. The ball 136 is typically made of plastic and has a 3-inch diameter. Similar to a wiffleball, the ball 136 has through holes throughout the surface. Different types (e.g., with different levels of hardness and different sizes of the through holes) may be used for playing the game on the various types of pickleball courts (e.g., indoor, outdoor, hard surface, soft surface etc.).

Pickleball can be played as singles or doubles, and is most commonly played as doubles. Each point begins with an underarm serve. The serve is performed diagonally beginning at the right-hand service square. A valid serve sends the ball from one left serve area to the other left serve area or from one right serve area to the other right serve area. The serve must clear the non-volley-zone. The serve must bounce before being hit by the receiver. The return of serve must also bounce before being hit (this is known as the 2 bounce rule). After the serve and the return of the serve, the ball can land anywhere on the opposite side of the playing surface 130. Volleys can only be performed outside of the non-volley zone. Volleys, that is, hitting the ball in the air without first letting it bounce, can only be made after the 2 bounce rule has been followed. However, if the ball is hit from within the kitchen, then it cannot land in the kitchen on the other side of the net.

A fault is any action that stops play due to a rule violation. A fault by the receiving team results in the servers earning a point. A fault by the serving team results in the server's loss of service and/or side out. A fault is committed when the serve touches any part of the non-volley zone (including the line) or the ball is hit out of bounds.

Pickleball games are typically played without a referee and are self-judged. Each player makes the line calls as to whether the ball is in or out when the ball contacts the playing surface on that player's side. The game continues to at least 11 points and requires a 2-point difference for a win. FIG. 1B shows another view of a pickleball court.

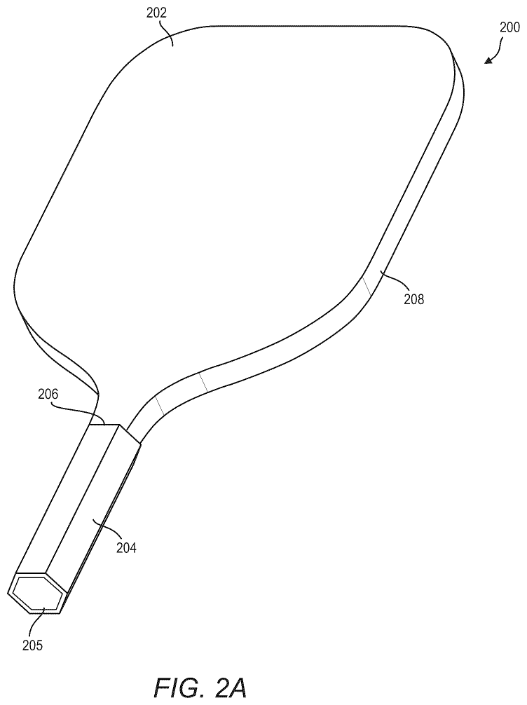

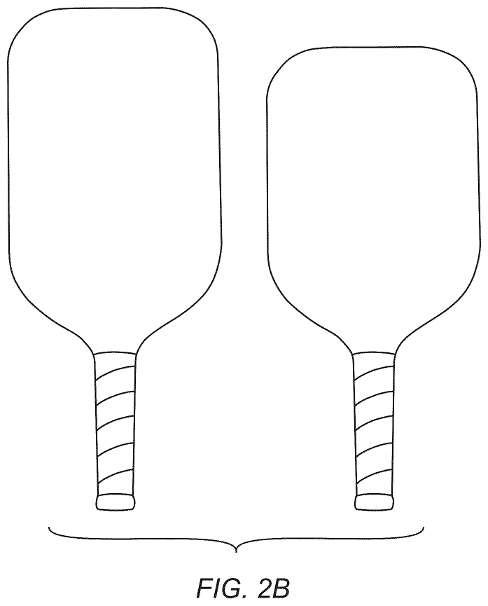

A conventional pickleball paddle is shown in FIG. 2A. In some example embodiments, as shown for example in FIG. 2A, a pickleball paddle 200 may comprise a striking blade 202 and a handle 204 connected to the striking blade. A grip 206 may wrap around a portion of the handle 204 and may comprise of a material that is more comfortable and/or provides better control of the paddle. The grip 206 is the portion of the handle that is intended to be held by the player during play (e.g., to strike and return a ball during play). The striking blade 202 comprises two striking surfaces 203, a core sandwiched between the striking surfaces, and, optionally, a frame (also referred to as an edge) 208 surrounding the striking surfaces 203. A striking surface 203 may also be referred to as a face of the striking blade 202 and is intended to be the portion of the striking blade 202 with which to strike the pickleball ball. During a pickleball game, based on the ball position and/or player position on the pickleball court, the player may use either the front face or the back face of the striking blade (e.g., corresponding to the front and back of the pickleball paddle, respectively) for any shot. The core of the striking blade may be constructed from materials such as, for example, hardened rubber, plastic, rubber/plastic compound, polymer, aluminum, honeycomb composite, etc., The striking surface 203 may comprise one or more layers of materials such as, for example, hardened rubber, plastic, rubber/plastic compound, fiberglass, carbon fiber, graphite, etc., that are conducive to striking/returning the pickleball ball and/or controlling the behavior of the ball. The striking surface 203 may be configured with a particular hardness (e.g., using the same or different material or material combination as in the rest of the striking surface) in an area referred to as “sweet spot” intended to provide the primary area of contact with the pickleball. The frame 208 may be constructed with a wood, plastic and/or hard rubber or compound thereof to encompass and provide support to the striking surface. The frame 208 may be integrated with or connected to the handle 204 at a connection area (also referred to as a connection part or connection point). The handle 204 may be the lower portion of a part/member (e.g., constructed of the same or different material(s) as the handle 204) that extends to the top of the striking blade (e.g., to the frame 208 at the top of the striking blade) or part way through the middle/core of the striking blade, and may be integrated/connected with the frame 208 in the connecting area (connecting part).

In a conventional pickleball paddle such as that shown in FIG. 2A, the entire paddle has the same center axis. That is, a center axis of the striking blade 202 and the center axis 212 of the handle 204 are parallel and are aligned with each other. Some pickleball paddles may include a butt cap 205 affixed to the bottom of the handle 204.

FIG. 2B shows two examples of commonly available pickleball paddles. The example pickleball paddle on the left side has a more elongated striking blade than the example paddle on the right side, providing a larger striking surface. Each example pickleball paddle in FIG. 2B, similar to that in FIG. 2A, has an edge that is of a concave shape on either side (left and right) of the handle and then curves upward before extending up in a straight line. In each example paddle shown in FIG. 2B the center axes (not shown in FIG. 2B) of the striking blade and the handle are the same.

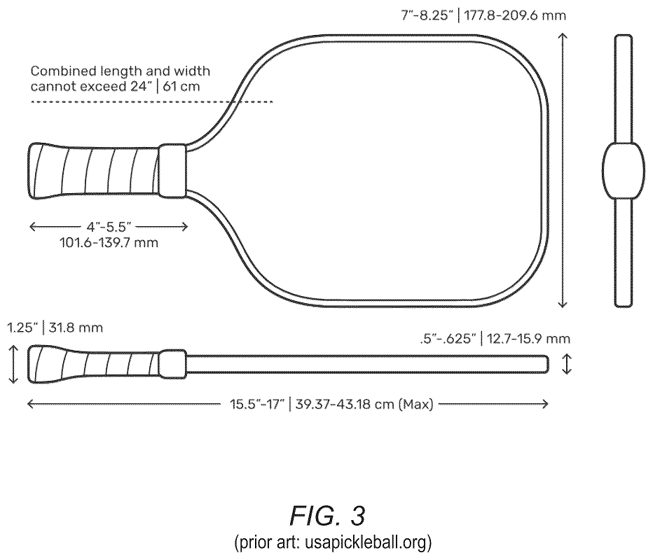

FIG. 3 shows example pickleball paddle specifications and standards according to USA Pickleball—the United States Pickleball Association. The current USA Pickleball specifications require that the combined length and width of a pickleball paddle cannot exceed 24 inches. The illustrated example paddle specification shows a paddle shape that can provide for a total length (handle and striking blade) of 15.5″-17″ inches and a width of 7″-8.25″. The paddle length may not exceed 17 inches (43.18 cm). Not mandated by USA Pickleball, but illustrated in FIG. 3 for an example pickleball paddle, are a thickness of 0.5″ -0.625″ of the striking blade, a thickness of 1.25″ at the bottom of the handle, and a length of 4″ -5.5″ of the handle. The side profile view at the bottom of the figure illustrates the profile view from the long side of the example paddle, and the side profile view shown on the right illustrates the profile view from the top-side of the paddle.

In the specification, the handle is an extension of the paddle face and may not exceed 5 inches (12.7 cm) in length, and the handle must be an integral part of the paddle face. It should not have any separate components or extensions beyond the permitted length. The handle should have a smooth surface without any protrusions, attachments, or features that could cause injury to players or interfere with gameplay. The handle, like the rest of the paddle, must be constructed of approved materials. Common materials include wood, composite materials, or graphite.

Paddle construction plays a significant role in overall performance of a pickleball paddle and/or a player's experience on the court. As noted above, various materials are used to craft pickleball paddles. There are at least three main components to a pickleball paddle construction: the face, the core, and the handle. The face (also referred to as striking surface or face sheet) of a pickleball paddle is the hitting surface that comes into direct contact with the ball. Paddle faces may be made from a variety of materials, each offering different properties. The core (core layer) is the inner structure of the pickleball paddle that lies sandwiched between the two faces of the paddle. It provides the paddle with its structural integrity. In many examples, the core is the primary determinant of the paddle's structural integrity as other parts of the paddle such as face sheets, edge guard, and the handle are connected to the core. The core can be made from any of several construction materials, and each construction material may affect the paddle's weight, control, and/or power, etc., differently. The structure (structural design) of the core can also, in addition to the paddle's structural integrity, affect the paddle's characteristic such as, for example, weight, balance, control and/or power. An example core structure is the honeycomb pattern. The handle is the grip portion of the paddle, and it is where players hold the paddle during play. Handle construction may influence a player's grip comfort, maneuverability, and/or overall control. Paddles may be constructed with a grip size and handle length. A paddle may include an edge guard. An edge guard is a strip that may surround the perimeter of the paddle face. An edge guard may help protect the paddle from damage during rallies and/or scrapes on the court. A paddle may be edgeless. An edgeless paddle may provide a player with a bigger paddle face, and/or a larger sweet spot.

A honeycomb structure in the core may create a lightweight, sturdy base for the paddle. Paddle cores may vary by material and thickness. Thinner paddles (e.g., around 13 mm) may be designed for power and thicker paddles (e.g. around 16 mm) may be designed for control. U.S. Patent Publication No. 2021/0252356A1 illustrates several example paddle core designs and construction materials. For example, various materials could be used to create a honeycomb structure for a paddle core, which may affect the paddle's performance. Some example paddle core materials include wood, foam, Nomex®, aluminum, carbon fiber, polymer, polypropylene, and/or the like. In an example, wood core paddles may offer a solid, lively feel. Wood may be a relatively heavy material compared with other alternatives. Wooden designs may be limited to shorter and thinner paddles which may produce relatively high speed and power. There are many different types of foam cores, for example, ethyl vinyl acetate (EVA), expanded polystyrene (EPS), or expanded polypropylene (EPP). Different types of foam may have different characteristics. Paddles with foam cores may offer a quieter playing experience. The foam may dampen impact by absorbing vibrations. Nomex® cores may be more durable compared with foam or honeycomb plastic. They may offer higher ball return power. Some players may lose some degree of control due to higher return speed of the ball off the paddle with Nomex and/or foam. Aluminum cores may be relatively lightweight and/or may offer good control. Carbon fiber may be used as a paddle core material. A carbon fiber core may offer good strength and stiffness. Polymer and/or polypropylene cores may offer a broad range of playing characteristics, from soft touch and control to power and spin. Other core structures (core construction technologies) including a combination of one or more of honeycomb plastic, carbon fiber, and/or foam, and other materials may be designed. In some examples, a paddle core may comprise of multiple layers.

In a pickleball paddle, the core may be sandwiched between two paddle face sheets. The face sheets may be constructed with composite materials that are built to withstand the repetitive striking of the ball on the paddle. There are varying materials used to create the face sheets. Carbon fiber faces may be lightweight and have a relatively high strength-to-weight ratio. Carbon fiber is a relatively durable material. Paddle faces (face sheets) may be built of fiberglass. Paddle faces may be built of graphite. Paddle faces may be built of Kevlar®. Kevlar is a relatively high-strength, lightweight material that is durable and resistant to abrasion. Alternatively, other materials may be used to build a paddle face sheet.

Carbon fiber is a relatively stiff, durable material that may offer a refined touch and feel due to the material absorbing a pickleball's energy at impact and more evenly distributing it across the face of the paddle. The result may be less deformation on contact, meaning greater control and/or shot precision. Carbon fiber face may be made of multiple layers to improve texture, strength, durability, vibration dampening, and/or other performance metrics. Fiberglass is a composite material that typically has less stiffness than carbon fiber, which may imply that paddles made with fiberglass may be more flexible on contact compared with paddles made with carbon fiber. Fiberglass may offer more rebound speed as the ball hits the paddle surface. The result may be a greater energy return to the ball resulting in a more powerful response. Fiberglass and/or carbon fiber face may be made of multiple layers to improve texture, strength, durability, vibration dampening, and/or other performance metrics.

Example carbon fiber surfaces include Carbon Friction Surface (CFS), Carbon Grip Surface (CGS), Carbon Touch Surface (CTS), and Carbon Abrasion Surface (CAS). Carbon Friction Surface (CFS) may be a textured surface that uses a longer-lasting, durable Carbon Flex 5 material. It may provide a performance with access to high levels of spin, optimal feel, and raw power. Carbon Grip Surface (CGS) may be a surface constructed from a durable, long-lasting Carbon Flex3 material for a textured surface that offers ball grip, feel and spin production. Carbon Touch Surface (CTS) may be a relatively smooth surface that reduces the amount of friction coming off the paddle allowing for enhanced feel and maximum control and touch.

Example fiber glass surface include Fiberglass Abrasion Surface and Carbon Abrasion Surface (CAS). An example Fiberglass Abrasion Surface may use a sand-blasted process that may create a fiberglass textured surface for enhanced spin. In an example, Carbon Abrasion Surface (CAS) may use a multi-step, abrasion sand-blasted process that creates a unique, textured surface offering increased spin. CAS paddles may feature a bottom layer (back layer) of fiberglass with a layer of carbon as or on the top layer (front layer).

Example pickleball paddle performance metrics (performance characteristics) include, dwell time, deflection, coefficient of restitution (COR), stiffness, and/or the like. These performance metrics may affect how balls deflect from the paddle, and may impact ball control, power, and pop. Other performance metrics may be considered. Some performance metrics may impact how fast the ball spins in response to paddle movement.

In an example, power refers to the court penetration a shot has, e.g. a steady speed that the ball travels over time. In an example, pop refers to a speed at which a ball comes off the paddle face. For example, pop is how much the ball naturally rebounds off the paddle face. For example, a paddle with low pop may have high power or court penetration if it were weighted enough and used with proper technique. The extra mass in the paddle may make hitting the ball harder and farther easier, as a player is moving a heavier object through the air when striking the ball.

In an example, dwell time refers to how long the ball stays on the paddle face after making contact. The longer a ball stays on the surface of a paddle, the greater the potential for generating spin. A trampoline type face may result in a longer dwell time and so might a textured surface. In an example, deflection may be how quickly the ball leaves the paddle face. Deflection refers to how far the face of a paddle moves (or deflects) when downward pressure is applied to the face surface. Thus, the degree of flex (e.g., the degree to which a portion of the paddle that is impacted by a ball bends) is a key aspect in controlling the dwell time.

In an example, the coefficient of restitution (COR) is a measurement of the ratio of the ball's final velocity to its initial velocity after being struck by the paddle. It is a measure of how bouncy the paddle is, or how efficiently energy is transferred between the ball and paddle during a collision. In an example, a stiffness may be a measure of the paddle resistance to deformation, and/or may be determined by a flow of impact energy. The average non-EVA paddle face may have a bending stiffness of about 900 lbs/in. A paddle may have a face and throat stiffness of 900-1100 lbs/in for high power.

Vibrations generated on the pickleball paddle each time when it strikes a ball can affect shots and moreover, over time, can affect a player's physical wellbeing. In particular, the vibrations can be transmitted to the player's hands through the handle when the player is tightly gripping the handle.

Pickleball paddle manufacturers have long since attempted to address the problem of vibrations generated on the striking blade. Many conventional pickleball paddles have foam injected all around the perimeter of the striking blade. Honeycomb cores also offer a good balance between power and vibration reduction.

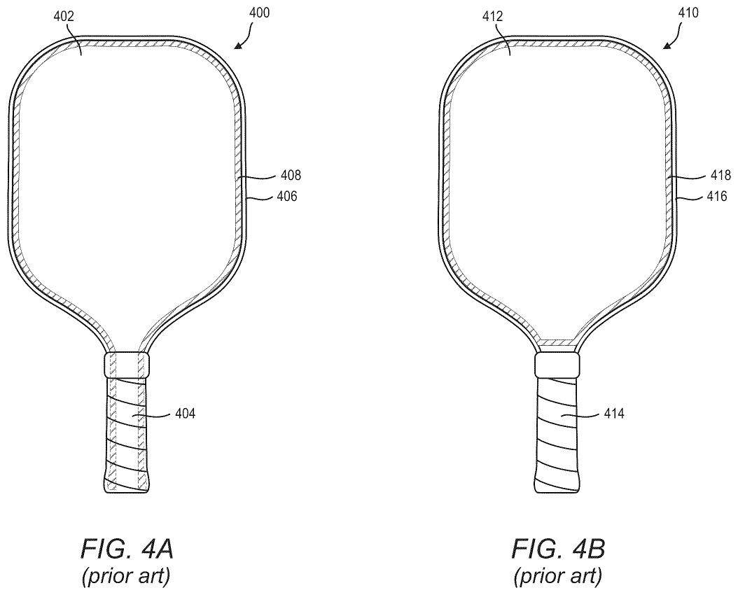

FIGS. 4A and 4B show example conventional pickleball paddles with each having a foam layer in at least some of the perimeter of its striking blade. The striking blades in FIGS. 4A and 4B do not have any holes within the boundaries of the striking blade that are configured for air flow. The pickleball paddle 400 shown in FIG. 4A comprises a striking blade 402 devoid of any openings (e.g., holes configured for air flow) within the boundaries of the striking blade and connected to a handle 404. The striking blade 402 may be constructed with a honeycomb core that is sandwiched between a front face sheet and a back face sheet. An edge guard 406 is attached to the perimeter of the striking blade 402 to protect the striking blade from damage and to facilitate firm bonding of the face sheets and the core. A layer of foam 408 is injected between the edge guard and the perimeter of the core of the striking blade 402. The foam may completely fill any space between the edge guard and the core. In some conventional paddles, the foam around the perimeter is injected and the striking blade core and face sheets with the foam layer is formed into a unitary striking blade before the edge guard, if any, is attached. In paddle 400, the layer of foam 408 extends from the perimeter of the core to the handle and surrounds the handle. Thus, when a player is gripping the handle, the foam layer intervenes between the grip of the handle and the handle's hard structure to further reduce vibrations being transmitted from the handle to the player's hands.

The pickleball paddle 410 shown in FIG. 4B comprises a striking blade 412 devoid of any openings (e.g., holes configured for air flow) within its boundaries connected to a handle 414. The striking blade 412 may be constructed with a honeycomb core that is sandwiched between a front face sheet and a back face sheet. An edge guard 416 is attached to the perimeter of the striking blade 412 to protect the striking blade from damage and to facilitate firm bonding of the face sheets and the core. A layer of foam 418 is injected between the edge guard and the perimeter of the core of the striking blade 412. The foam may completely fill any space between the edge guard and the core. In paddle 410, the layer of foam 418 extends along the left perimeter, the top perimeter, and the right perimeter of the core and connects the foam at the left perimeter with the foam at the right perimeter by extending in the throat area, above the handle 414. The fully connected ring of foam can significantly reduce vibrations that are transmitted to the handle 414.

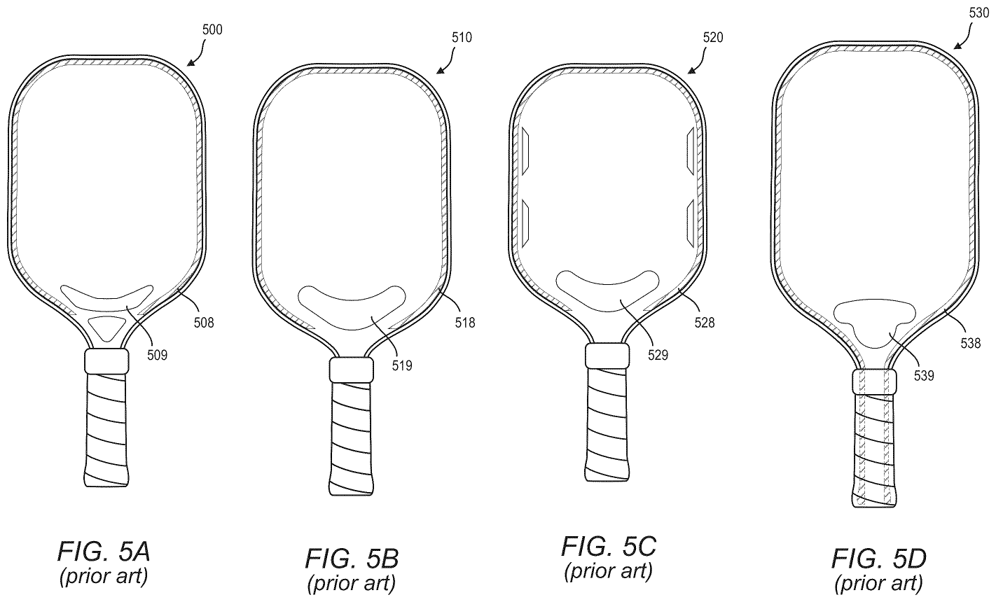

FIGS. 5A, 5B, 5C and 5D show example conventional pickleball paddles of which the striking blades each have one or more holes for improved air dynamics and weight adjustment, and in each of which at least some of the perimeter of the striking blade abuts a layer of soft material. Paddle 500 shown in FIG. 5A comprises a striking blade 502 connected to the handle 504. The striking blade 502 may include a core (e.g., a honeycomb core) sandwiched between two face sheets. The striking blade 502 includes two holes/openings configured for air flow and/or weight adjustment in the throat area above the top of the handle. A foam layer 508 extends along the perimeter of the core of the striking blade and helps in absorbing some of the vibrations generated on the striking blade by ball strikes.

Paddle 510 shown in FIG. 5B comprises a striking blade 512 connected to the handle 514. The striking blade 512 may include a core (e.g., a honeycomb core) sandwiched between two face sheets. The striking blade 512 includes one hole/opening 519 configured for air flow and/or weight adjustment in the throat area above the top of the handle. A foam layer 518 extends along the perimeter of the core of the striking blade and helps in absorbing some of the vibrations generated on the striking blade due by ball strikes.

Paddle 520 shown in FIG. 5C comprises a striking blade 522 connected to the handle 524. The striking blade 522 may include a core (e.g., a honeycomb core) sandwiched between two face sheets. The striking blade 522 includes a hole/opening 529 configured for air flow and/or weight adjustment in the throat area above the top of the handle. The striking blade also includes two elongated holes on the left and right sides of the striking blade 502 near the perimeter. A foam layer 528 extends along the perimeter of the core of the striking blade and helps in absorbing some of the vibrations generated on the striking blade by ball strikes.

Paddle 530 shown in FIG. 5D comprises a striking blade 532 connected to the handle 534. The striking blade 532 may include a core (e.g., a honeycomb core) sandwiched between two face sheets. The striking blade 532 includes a hole/opening configured for air flow and/or weight adjustment in the throat area above the top of the handle. A foam layer 538 extends along the perimeter of the core of the striking blade and into the grip area of the handle. The foam layer 538 helps in absorbing some of the vibrations generated on the striking blade by ball strikes.

The foam layers in paddles 500, 510, 520 and 530 substantially reduce the effects of vibrations on shots and on player wellbeing but further improved vibration reduction can be achieved for pickleball paddles.

Embodiments of the present disclosure provide further improved vibration reduction in pickleball paddles with striking blades that have holes/openings configured within in the striking blade. More particularly, embodiments of the present disclosure take advantage of the additional structure provided by such holes in the striking blade to add additional foam or other soft material configured such that vibrations generated by balls striking the striking blade can be further reduces and/or more effectively prevented from propagating to the player's hands.

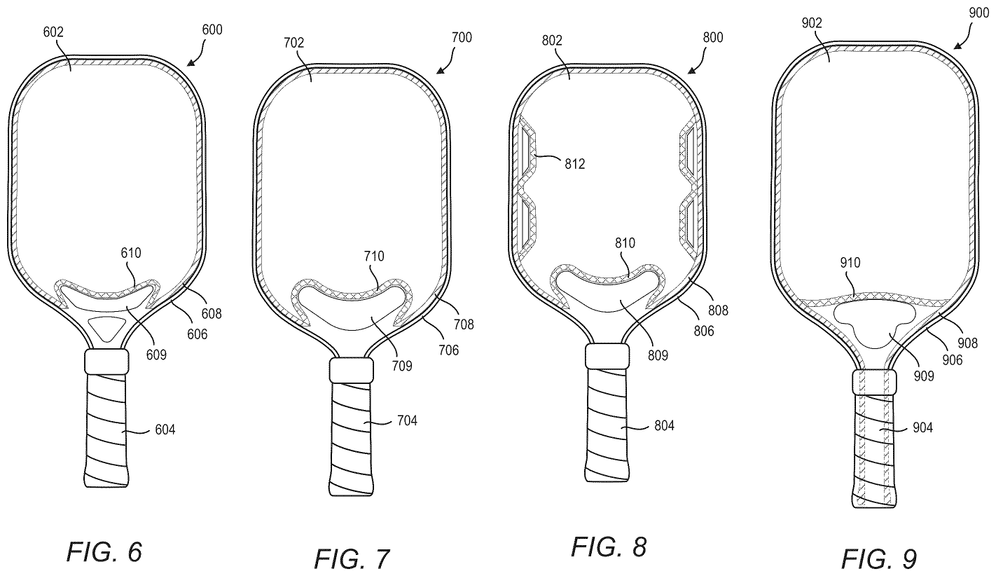

FIG. 6 shows a pickleball paddle 600 having a striking blade 602 with two holes 609 in the throat area of the striking blade 602 and configured with a first soft material layer 608 abutting the perimeter of the striking blade 602 and a second soft material layer 610 abutting one of the holes 609 in the throat area of the striking blade, according to some embodiments. The first soft material layer 608 may be injected or formed in between the perimeter of the core of the striking blade and edge guard 606. The first soft material layer 608 that abuts the perimeter of the striking blade is connected to the second soft material layer 610 that abuts at least some of the perimeter of the hole 609 so that the soft material forms a fully connected ring around the area of the striking blade 602 in which ball strikes typically occur and thereby more effectively absorbs vibrations before they can propagate to the hand of the player. In paddle 600, the additional structure provided by the hole/opening 609 within the boundaries of the striking blade 602 is used to improve the efficiency of the vibration reduction. Although two hole/openings exist within the borders of striking blade 602, by completing the ring of soft material layers above the lower (e.g., closer to the top of the handle 604) hole any further reduction of absorption achievable by adding soft material layers around the lower hole is reduced and thus the need for providing another soft material layer around the second hole is reduced.

The soft material in the first soft material layer 608 and/or the second soft material layer 610 can be foam. In some embodiments, the soft material can be any of soft polymeric material, foamed polymer, foam, gel, rubber, and/or sponge. These materials dampen vibration, and do not substantially impact the sweet spot, stiffness, or power of the hitting areas.

In some embodiments, a groove is cut into the striking blade abutting the top portion of the upper hole 609 and connecting on each side of the hole 509 to the perimeter of the core of the striking blade 602, and the soft material is injected into the groove. The groove is cut on both the front and back striking blade surfaces in the throat area above the top of the handle 604, while ensuring the strength and integrity of the striking blade 602 and its connection to the handle 604.

In some embodiments, the first soft material layer 608 and the second soft material layer 610 are made of the same material and the same configuration (e.g., thickness of the layer, shape of the layer). This makes manufacturing of the paddle easier because of the uniformity of the soft material layers. In some other embodiments, the first soft material layer 608 and second soft material layer 610 are made from different materials and/or material combinations, and/or may be differently configured in terms of the thickness and/or shape of the layer. In one example embodiment, the soft material layer 610 and the soft material layer 608 are made from the same material, and the soft material layer 610 is thicker at least in some places than the soft material layer 608. This embodiment takes advantage of the aspect that the layer 610, in contrast to layer 608, is located on the surface area of the striking blade 602 and also at least partially in surface areas that are unlikely to be struck by the ball. For example, the thickness of layer 610 can be the same as the thickness of layer 608 in the center area that is closest to the sweet spot of the striking blade and have increasing thickness as it curves on the sides of the hole towards the bottom part of the hole and then curves away from the hole to connect with the layer 608 at the two ends. In one example embodiment, the soft material layer 610 and the soft material layer 608 are made from different materials, and the soft material of soft material layer 610 is configured for higher efficiency vibration reduction than the soft material layer 608. This embodiment too takes advantage of the aspect that the layer 610, in contrast to layer 608, is located on the surface area of the striking blade and also at least partially in surface areas that are unlikely to be struck by the ball. For example, the soft material of layer 610 can increase moving away from the center area that is closest to the sweet spot of the striking blade and have increasing softness, and thus increasing efficiency of vibration absorption, as it curves on the sides of the hole towards the bottom part of the hole and then curves away from the hole to connect with the layer 608 at the two ends. In some embodiments, soft material layers 608 and 610 may be configured differently so that the vibration reduction efficiency of at least parts of soft material layer 610 that are away from the sweet spot is higher in relation to soft material layer 608.

In some embodiments, only the hole nearest the sweet spot is configured to have its perimeter abut the second layer of soft material for vibration absorption. For example, when the second layer 610 is configured to abut a top portion of the hole 609 nearest the sweet spot such that the first and second layers of soft materials form a connected ring, then any further reduction of vibrations that can be achieved by configuring the remainder of the hole 609 perimeter, such as the bottom portion of the perimeter, is minimal and thus it is not necessarily an added advantage to provide the additional soft material to abut the entire hole 609. For similar reasons, when there are two or more holes 609 in a manner similar to that shown in FIG. 6 and the second layer 610 is configured to abut a top portion of the hole 609 nearest the sweet spot such that the first and second layers of soft materials form a connected ring and the second hole is outside of the ring formed by the connected soft material layers, then any further reduction of vibrations that can be achieved by configuring the remainder of the hole 509 perimeter, such as the bottom portion of the perimeter, is minimal and thus it is not necessarily an added advantage to provide the additional soft material to abut the entire hole 609.

FIG. 7 shows a pickleball paddle having a striking blade with a hole in the throat area of the striking blade and configured with soft material layers abutting the perimeter of the striking blade and also abutting the hole in the throat area of the striking blade, according to some embodiments. FIG. 7 shows a pickleball paddle 700 having a striking blade 702 with one hole 709 in the throat area of the striking blade 702 and configured with a first soft material layer 708 abutting the perimeter of the striking blade 702 and a second soft material layer 710 abutting the hole 709 in the throat area of the striking blade 602, according to some embodiments. The first soft material layer 708 may be injected or formed in between the perimeter of the core of the striking blade and edge guard 706. The first soft material layer 708 that abuts the perimeter of the core of the striking blade 702 is connected to the second soft material layer 710 that abuts at least some of the perimeter of the hole 709 so that the soft material forms a fully connected ring around the area of the striking blade 702 in which ball strikes typically occur and thereby more effectively absorbs vibrations before they can propagate to the hand of the player. In paddle 700, the additional structure provided by the hole/opening within the boundaries of the striking blade is used to improve the efficiency of the vibration reduction.

The soft material in soft material layer 708 and/or soft material layer 710 can be foam. The soft filler material can be any of soft polymeric material, foamed polymer, foam, gel, rubber, and/or sponge. These materials dampen vibration, and do not substantially impact the sweet spot, stiffness, or power of the hitting areas.

In some embodiments, a groove is cut into the striking blade abutting the top portion of the upper hole and connecting on each side of the hole to the perimeter of the striking blade, and the soft material is injected to the groove. The groove is cut on both the front and back striking blade surfaces in the throat area above the top of the handle, while ensuring the strength and integrity of the striking blade and its connection to the handle.

In some embodiments, the soft material layer 708 and the soft material layer 710 are made of the same material and the same configuration (e.g., thickness of the layer, shape of the layer). This makes manufacturing of the paddle easier because of the uniformity of the soft material layers. In some other embodiments, the first soft material layer 708 and second layer 710 are made from different materials and/or material combinations, and/or may be differently configured in terms of the thickness and/or shape of the layer. In one example embodiment, the soft material layer 710 and the soft material layer 708 are made from the same material, and the soft material layer 710 is thicker at least in some places than the soft material layer 708. This embodiment takes advantage of the aspect that layer 710, in contrast to layer 708, is located on the surface area of the striking blade and also at least partially in surface areas that are unlikely (or less likely) to be struck by the ball. For example, the thickness of layer 710 can be the same as the thickness of layer 708 in the center area that is closest to the sweet spot of the striking blade and have increasing thickness as it curves on the sides of the hole towards the bottom part of the hole and then curves away from the hole to connect with the layer 608 at the two ends. In one example embodiment, the soft material layer 710 and the soft material layer 708 are made from different materials, and the soft material of soft material layer 710 is configured for higher efficiency vibration reduction than the soft material layer 708. This embodiment too takes advantage of the aspect that the layer 710, in contrast to layer 708, is located on the surface area of the striking blade and also at least partially in surface areas that are unlikely to be struck by the ball. For example, the soft material of layer 710 can increase moving away from the center area that is closest to the sweet spot of the striking blade and have increasing softness, and thus increasing efficiency of vibration absorption, as it curves on the sides of the hole towards the bottom part of the hole and then curves away from the hole to connect with the layer 708 at the two ends. In some embodiments, soft material layers 708 and 710 may be configured differently so that the vibration reduction efficiency of at least parts of second soft material layer 710 that are away from the sweet spot is higher in relation to first soft material layer 708.

FIG. 8 shows a pickleball paddle having a striking blade with one hole in the throat area and two holes on each of the left and right sides near the perimeter and configured with soft material layers abutting the perimeter of the striking blade and also abutting the holes on the striking blade, according to some embodiments. FIG. 8 shows a pickleball paddle 800 having a striking blade 802 with one hole 809 in the throat area of the striking blade 802 and configured with a first soft material layer 808 abutting the perimeter of the striking blade 802 and a second soft material layers 810 that abuts at least part of the perimeter of the hole 809 in the throat area of the striking blade and the parts of the perimeters of the holes arranged on the left and right of the striking blade, according to some embodiments. The first soft material layer 808 may be injected or formed in between the perimeter of the core of the striking blade and edge guard 806. The soft material layer 808 that abuts the perimeter of the core of the striking blade is connected to one of the soft material layers 810 that abuts at least some of the perimeter of the hole 809 in the throat area so that the soft material forms a fully connected ring around the area of the striking blade 802 in which ball strikes typically occur and thereby more effectively absorbs vibrations before they can propagate to the hand of the player. In paddle 800, the additional structure provided by the holes/openings within the boundaries of the striking blade are used to improve the efficiency of the vibration reduction.

The soft material in soft material layer 808 and/or soft material layer 810 can be foam. The soft filler material can be any of soft polymeric material, foamed polymer, foam, gel, rubber, and/or sponge. These materials dampen vibration, and do not substantially impact the sweet spot, stiffness, or power of the hitting areas.

In some embodiments, a groove is cut into the striking blade abutting the top portion of the upper hole and connecting on each side of the hole to the perimeter of the striking blade, and the soft material is injected into the groove. The groove is cut on both the front and back striking blade surfaces in the throat area above the top of the handle, while ensuring the strength and integrity of the striking blade and its connection to the handle.

In some embodiments, the soft material layer 808 and the soft material layer 810 are made of the same material and the same configuration (e.g., thickness of the layer, shape of the layer). This makes manufacturing of the paddle easier because of the uniformity of the soft material layers. In some other embodiments, the first soft material layer 808 and second layer 810 are made from different materials and/or material combinations, and/or may be differently configured in terms of the thickness and/or shape of the layer. In one example embodiment, the soft material layer 810 and the soft material layer 808 are made from the same material, and the soft material layer 810 is thicker at least in some places than the soft material layer 808. This embodiment takes advantage of the aspect that the layer 810, in contrast to layer 808, is located on the surface area of the striking blade and also at least partially in surface areas that are unlikely to be struck by the ball. For example, the thickness of layer 810 can be the same as the thickness of layer 808 in the center area that is closest to the sweet spot of the striking blade and have increasing thickness as it curves on the sides of the hole towards the bottom part of the hole and then curves away from the hole to connect with the layer 808 at the two ends. In one example embodiment, the soft material layer 810 and the soft material layer 808 are made from different materials, and the soft material of soft material layer 810 is configured for higher efficiency vibration reduction than the soft material layer 808. This embodiment too takes advantage of the aspect that the layer 810, in contrast to layer 808, is located on the surface area of the striking blade and also at least partially in surface areas that are unlikely to be struck by the ball. For example, the soft material of layer 810 can increase moving away from the center area that is closest to the sweet spot of the striking blade and have increasing softness, and thus increasing efficiency of vibration absorption, as it curves on the sides of the hole towards the bottom part of the hole and then curves away from the hole to connect with the layer 808 at the two ends. In some embodiments, soft material layers 808 and 810 may be configured differently so that the vibration reduction efficiency of at least parts of soft material layer 810 that are away from the sweet spot is higher in relation to soft material layer 808.

In some embodiments, the hole 809 in the throat area and the four holes on the left and right of the striking blade have only parts of their perimeters abutting a soft material. For example, for each of the holes, only the part of the perimeters that is closest to the sweet spot is provided with the abutting soft material. For example, when a front perimeter, which is facing the sweet spot area, of any of the holes is configured to reduce vibrations using an abutting soft material, there is a decreasing marginal benefit in having the back perimeter, which does not face the sweet spot, abutting a soft material. Thus, for example in the shown embodiment of FIG. 8, for each of the holes in the throat area and in the left and right of the striking blade, only a front part of the perimeter that faces the sweet spot is provided with abutting soft material for vibration dampening and the remainder of the perimeter of each of the holes may immediately abut the core of the striking blade.

FIG. 9 shows a pickleball paddle having a striking blade with a hole in the throat area and configured with soft material layers abutting the perimeter of the striking blade and also abutting at least one of the one or more holes on the striking blade, according to some embodiments. FIG. 9 shows a pickleball paddle 900 having a striking blade 902 with one hole 909 in the throat area of the striking blade 902 and configured with soft material layers 908 abutting the perimeter of the striking blade 902 and soft material layer 910 abutting the hole 909 in the throat area of the striking blade, according to some embodiments. The first soft material layer 908 may be injected or formed in between the perimeter of the core of the striking blade and edge guard 906. The soft material layer 908 that abuts the perimeter is connected to the soft material layer 910 that abuts at least some of the perimeter of the hole 909 so that the soft material forms a fully connected ring around the area of the striking blade 902 in which ball strikes typically occur and thereby more effectively absorbs vibrations before they can propagate to the hand of the player. In paddle 900, the additional structure provided by the hole/opening within the boundaries of the striking blade is used to improve the efficiency of the vibration reduction.

The soft material in soft material layer 908 and/or soft material layer 910 can be foam. The soft filler material can be any of soft polymeric material, foamed polymer, foam, gel, rubber, and/or sponge. These materials dampen vibration, and do not substantially impact the sweet spot, stiffness, or power of the hitting areas.

In some embodiments, a groove is cut into the striking blade abutting the top portion of the upper hole and connecting on each side of the hole to the perimeter of the striking blade, and the soft material is injected to the groove. The groove is cut on both the front and back striking blade surfaces in the throat area above the top of the handle, while ensuring the strength and integrity of the striking blade and its connection to the handle.

In some embodiments, the soft material layer 908 and the soft material layer 910 are made of the same material and the same configuration (e.g., thickness of the layer, shape of the layer). This makes manufacturing of the paddle easier because of the uniformity of the soft material layers. In some other embodiments, the first soft material layer 908 and second layer 910 are made from different materials and/or material combinations, and/or may be differently configured in terms of the thickness and/or shape of the layer. In one example embodiment, the soft material layer 910 and the soft material layer 908 are made from the same material, and the soft material layer 910 is thicker at least in some places than the soft material layer 908. This embodiment takes advantage of the aspect that the layer 910, in contrast to layer 908, is located on the surface area of the striking blade and also at least partially in surface areas that are unlikely to be struck by the ball. For example, the thickness of layer 910 can be the same as the thickness of layer 908 in the center area that is closest to the sweet spot of the striking blade and have increasing thickness as it curves on the sides of the hole towards the bottom part of the hole and then curves away from the hole to connect with the layer 908 at the two ends. In one example embodiment, the soft material layer 910 and the soft material layer 908 are made from different materials, and the soft material of soft material layer 910 is configured for higher efficiency vibration reduction than the soft material layer 908. This embodiment too takes advantage of the aspect that the layer 910, in contrast to layer 908, is located on the surface area of the striking blade and also at least partially in surface areas that are unlikely to be struck by the ball. For example, the soft material of layer 910 can increase moving away from the center area that is closest to the sweet spot of the striking blade and have increasing softness, and thus increasing efficiency of vibration absorption, as it curves on the sides of the hole towards the bottom part of the hole and then curves away from the hole to connect with the layer 908 at the two ends. In some embodiments, soft material layers 908 and 910 may be configured differently so that the vibration reduction efficiency of at least parts of soft material layer 910 that are away from the sweet spot is higher in relation to soft material layer 908.

Enhanced vibration dampening in pickleball paddles striking blades with holes according to embodiments of this disclosure are designed to increase the life span of pickleball paddles, to enable more accurate shots, and for improved player health and comfort. Embodiments of the present disclosure are not limited to the sizes, numbers, shapes, and/or particular arrangements of internal holes within the boundaries of the striking blades shown in the figures, and some embodiments may include striking blades and/or holes that are differently sized or differently shaped than those specifically described or shown. It should also be understood that further embodiments may include combinations of features of embodiments that are shown in the figures.

It should be noted that embodiments of the present disclosure are not limited to particular shapes of pickleball paddles or particular construction materials of the frame, core and/or face sheets. Although various embodiments have been shown and described in detail, the claims are not limited to any particular embodiment or example. CLAIMS:

1. A pickleball paddle comprising:
a handle; and
a striking blade with one or more holes located in the striking blade,
wherein at least some of a perimeter of the striking blade abuts a first layer of soft material and at least some of a perimeter of at least one of the one or more holes abut a second layer of soft material.

2. The pickleball paddle of claim 1, wherein the soft material of the first layer and/or the second layer comprises soft polymeric material, foamed polymer, foam, gel, and/or sponge.

3. The pickleball paddle of claim 1, further comprising an edge guard, wherein at least a part of the first layer of soft material is between the edge guard and the perimeter of the striking blade.

4. The pickleball paddle of claim 1, wherein the first layer is between:
an edge guard of the pickleball paddle; and
a core of the pickleball paddle.

5. The pickleball paddle of claim 1, wherein the second layer is between:
the at least some of a perimeter of at least one of the one or more holes; and
a core of the pickleball paddle.

6. The pickleball paddle of claim 1, wherein the first layer and the second layer are connected to each other to form a connected layer.

7. The pickleball paddle of claim 6, wherein the first layer and the second layer are connected to each other to form a circularly connected layer.

8. The pickleball paddle of claim 7, wherein the second layer is formed in a groove configured on the striking blade.

9. The pickleball paddle of claim 1, wherein the second layer is thicker than the first layer.

10. The pickleball paddle of claim 1, wherein the second layer is of a different soft material than the first layer.

11. The pickleball paddle of claim 1, wherein the first and second layers are of the same soft material.

12. The pickleball paddle of claim 1, wherein the second material is configured for greater absorption of vibrations than the first layer.

13. The pickleball paddle of claim 1, wherein the second layer abuts only a part of the perimeter of the any one of the one or more holes.

14. The pickleball paddle of claim 13, wherein the part of the perimeter that abuts the second layer is closer to a sweet spot of the striking blade than a part of the perimeter that is away from the sweet spot.

15. The pickleball paddle of claim 1, wherein a core of the striking blade comprises a honeycomb layer.

16. The pickleball paddle of claim 15, wherein the core is attached to two face sheet layers.
